(19) United States
(12) Patent Application Publication
(10) Pub. No.: US 2025/0008318 A1
(43) Pub. Date: Jan. 2, 2025

(54) METHOD AND APPRATUS FOR CAPABILITY REPORTING IN RELAY COMMUNICATIONS

(71) Applicant: MEDIATEK INC., Hsinchu City (TW)

(72) Inventors: Guan-Yu LIN, Hsinchu City (TW); Chia-Hao YU, Hsinchu City (TW); Lung-Sheng TSAI, Hsinchu City (TW); Nathan Edward TENNY, San Jose, CA (US)

(21) Appl. No.: 18/711,002

(22) PCT Filed: Jan. 10, 2023
(86) PCT No.: PCT/CN2023/071682

§ 371 Date: May 16, 2024

Related U.S. Application Data
(60) Provisional application No. 63/297,850, filed on Jan. 10, 2022.

(51) Int. Cl. H04W 8/24; H04W 88/04

(52) U.S. Cl. CPC H04W 8/24; H04W 88/04

(57) ABSTRACT

A synergetic communication method for capability reporting in relay communications is proposed. A user equipment (UE) may detect the relay node(s). In an event that a trigger condition is triggered, the UE may transmit the capability report associated with the detected relay node to the network node. The network node may generate the resource configuration based on the capability report from the UE. Therefore, the network node is able to obtain the capability information of the relay node even if the relay node has limited capability, e.g., the relay node is a layer 0 (L0) relay node or a layer 1 (L1) relay node.

### CROSS REFERENCE TO RELATED APPLICATIONS

This application claims priority under 35 U.S.C. § 119 from U.S. Provisional Application No. 63/297,850, entitled “Capability report to support synergetic UE Communication”, filed on Jan. 10, 2022, the subject matter of which is incorporated herein by reference.

### TECHNICAL FIELD

The disclosed embodiments relate generally to wireless communication, and, more particularly, to capability reporting in relay communications.

### BACKGROUND

The wireless communications network has grown exponentially over the years. A long-term evolution (LTE) system offers high peak data rates, low latency, improved system capacity, and low operating cost resulting from simplified network architecture. LTE systems, also known as the 4G system, also provide seamless integration to older wireless network, such as GSM, CDMA and universal mobile telecommunication system (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3^{rd} generation partner project (3GPP) network normally includes a hybrid of 2G/3G/4G systems. The next generation mobile network (NGMN) board, has decided to focus the future NOMN activities on defining the requirements for 5G new radio (NR) systems or 6G systems.

In conventional 5G technology, the relay communication via a relay node has the potential to modernize mobile communications for vehicles or other application scenarios. However, when the relay node is not able to directly communicates with the network node due to the limited capability information of the relay node, e.g., the relay node is a layer 0 (L0) relay node or a layer 1 (L1) relay node, the network node is not able to obtain the capability information of the relay node.

A solution for capability reporting is sought.

### SUMMARY

A synergetic communication method for capability reporting in relay communications is proposed. A user equipment (UE) may detect the relay node(s). In an event that a trigger condition is triggered, the UE may transmit the capability report associated with the detected relay node to the network node. The network node may generate the resource configuration based on the capability report from the UE and schedule the scheduling to the UE based on the resource configuration. Therefore, the network node is able to obtain the capability of the relay node even if the relay node has limited capability, e.g., the relay node is a layer 0 (L0) relay node or a layer 1 (L1) relay node.

In one embodiment, a user equipment (UE) detects at least one relay node. The UE transmits a capability report associated with the at least one relay node to a network node in an event that a trigger condition is triggered. The trigger condition comprises that at least one relay node is changed, the capability information of at least one relay node is changed, or a serving cell of the UE is changed.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary synergetic communication network in accordance with aspects of the current invention.

FIG. 2A is a schematic diagram of an aggregated group in accordance with one novel aspect.

FIG. 2B is a schematic diagram of an aggregated group in accordance with another novel aspect.

FIG. 2C is a schematic diagram of an aggregated group in accordance with another novel aspect.

FIG. 3 is a simplified block diagram of a network node and a user equipment that carry out certain embodiments of the present invention.

FIG. 4 illustrates a capability reporting in accordance with one novel aspect.

FIG. 5 is a flow chart of a capability reporting method in accordance with one novel aspect.

### DETAILED DESCRIPTION

Reference will now be made in detail to some embodiments of the invention, examples of which are illustrated in the accompanying drawings.

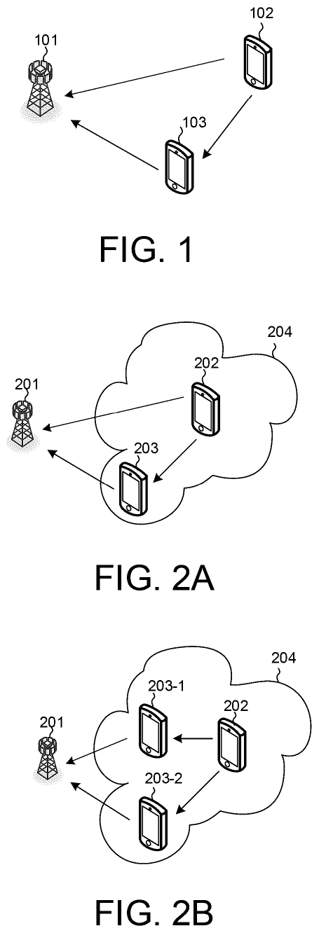

FIG. 1 illustrates an exemplary synergetic communication network in accordance with aspects of the current invention. The synergetic communication network comprises a network node 101, a user equipment (UE) 102 and at least one relay node 103. It should be noted that FIG. 1 only shows one relay node 103, but the invention should not be limited thereto. The synergetic communication network may comprise more than one relay node. The synergetic communication network may be applied to Sidelink (SL) communication or other relay communications.

The network node 101 may be communicatively connected to a user equipment (UE) 102 operating in a licensed band (e.g., 30 GHz˜300 GHz for mmWave) of an access network which provides radio access using a Radio Access Technology (RAT) (e.g., the 5G NR technology). The access network may be connected to a 5G core network by means of the NG interface, more specifically to a User Plane Function (UPF) by means of the NG user-plane part (NG-u), and to a Mobility Management Function (AMF) by means of the NG control-plane part (NG-c). One gNB can be connected to multiple UPFs/AMFs for the purpose of load sharing and redundancy.

The network node 101 may be a base station (BS) or a gNB.

The UE 102 may be a smart phone, a wearable device, an Internet of Things (IoT) device, and a tablet, etc. Alternatively, UE 102 may be a Notebook (NB) or Personal Computer (PC) inserted or installed with a data card which includes a modem and RF transceiver(s) to provide the functionality of wireless communication.

The relay node 103 may be a layer 2 (L2) relay node, a layer 1 (L1) relay node or a layer 0 (L0) relay node.

L2 relay node may have capability of decoding the received packets to the level of L2 packets (i.e., in the unit of Medium-Access-Control Protocol-Data-Unit (MAC PDU), MAC Service Data Unit (SDU), RLC SDU, Radio Link Control (RLC) PDU, Packet Data Convergence Protocol (PDCP) SDU, or PDCP PDU), assembling the received L2 packets to form a new MAC PDU and forwarding the new MAC PDU to the next hop. That is to say, the L2 relay node may have similar functionalities as the UE 102. In L2 relay, a L2 relay node connects to the network before it transmits discovery message to announce itself as a L2 relay UE. During network connection establishment, a L2 relay node directly obtains the relay node identification (ID) from the network node 101 (same as legacy UE). That is, L2 relay node has capability to acquire its distinct network-recognizable ID (i.e., Cell-Radio Network Temporary Identifier (C-RNTI)) from the network directly.

L1 relay node may have functionalities between L0 relay node and L2 relay node. In an example, L1 relay node does not do L2 decoding for received control signaling and data which is to be forwarded to the network or other UE but is not for itself. In another example, the L1 relay node may support L2 decoding for its own control signaling, i.e. L1 relay node may be configured by L1 (e.g., Channel State Information (CSI) and/or Downlink Control Information, DCI) or L2 signaling (MAC Control Element (CE) or Radio Resource Control (RRC) configuration). L1 relay node may perform L1 procedure such as beam management, power control, or time slot specific on-off operation, which may follow the instruction of the received control signaling from the network. L1 relay node may not directly obtain the relay node identification (ID) from the network node 101, i.e., a L1 relay node may not have a UE ID (e.g., C-RNTI for network recognition) assigned by the network.

L0 relay node may only have the capability of amplifying and forwarding the received signal. L0 relay node may not directly obtain the relay node identification (ID) from the network node 101 (e.g., C-RNTI).

In accordance with one novel aspect, the UE 102 and the relay node(s) 103 may form an aggregated group. The UE 102 may coordinate the operations in the aggregated group. Taking FIG. 2A and FIG. 2B as examples. As shown in FIG. 2A, UE 202 and relay node 203 may form an aggregated group 204. As shown in FIG. 2B, UE 202, relay node 203-1 and relay node 203-2 may form an aggregated group 204. The type of aggregated group may be based on the type of the relay node(s) (e.g., the relay node is L2 relay node, L1 relay node or L0 relay node) in the aggregated group.

In accordance with another novel aspect, the relay nodes 103 may form an aggregated group, i.e., the aggregated group does not comprise the UE 102. In the aggregated group, a relay node 103 may be regarded as a master relay node (or relay node lead) which has better capability than other relay nodes 103 of the aggregated group, e.g., the master relay node is a L2 relay node and other relay nodes of the aggregated group are L1 relay nodes or L0 relay node. Taking FIG. 2C as an example. As shown in FIG. 2C, the aggregated group 204 may comprise the relay node 203-1 and relay node 203-2 and the relay node 203-1 is the master relay node. The master relay node may coordinate the operations in the aggregated group.

In accordance with a novel aspect, the UE 102 may detect the relay node 103. After the UE 102 detects the relay node 103, the UE 102 may obtain the capability information from the detected relay node 103. When a trigger condition is triggered, the UE 102 may transmit a capability report associated with the relay node 103 to the network node 101.

In accordance with a novel aspect, the trigger condition may comprise that the relay node 103 is changed, e.g., the number of the detected relay nodes 103 is changed. For an example, a new relay node 103 may be added into the aggregated group (e.g., the UE 102 detect a new relay node 103) or the relay node 103 may be removed from the aggregated group (e.g., the relay node 103 in the aggregated group is not able to be used). When the number of the relay nodes 103 is changed, the UE 102 may transmit the capability report associated with the current relay node(s) 103 in the aggregated group to the network node 101. In accordance with another novel aspect, the trigger condition may comprise that the capability information of at least one relay node is changed. A relay node 103 may have different capability information corresponding to different configuration, e.g., the operating frequency, the operating bandwidth, or channel condition of the relay UE. The UE 102 may not need to report all capability information of the relay node 103 to the network node 101, and instead just need to report the required capability information (e.g., corresponding to the current configuration of operating frequency, bandwidth or channel condition of the relay UE 103). By this way, the signaling overhead for capability report can be reduced. If network node 101 changes some configuration leading to a change of capability information of relay node 103, the UE 102 then needs to report the updated capability information corresponding to the new network configuration change. In accordance with another novel aspect, the trigger condition may comprise that the UE 102 changes its serving cell.

In accordance with a novel aspect, the capability report comprises capability information of the relay node 103 and/or the UE 102. That is, in an example, the UE 102 may transmit the capability report comprising the capability information of the relay node 103 and the UE 102 to the network node 101. In another example, the UE 102 may transmit separated capability reports respectively corresponding to the capability information of the relay node 103 and the capability 10 information of the UE 102 to the network node 101.

In accordance with a novel aspect, the capability information of the relay node 103 may comprise the relay type of the relay node 103, e.g., the relay node 103 is L0 relay node, L1 relay node or L2 relay node. Different relay nodes 103 may comprise the same or different relay types. In addition, one relay node 103 may comprise more than one relay type, e.g., the relay node 103 has the functions of L2 relay node and the L1 relay node, or the relay node 103 has the functions of L0 relay node and the L1 relay node, but the invention should not be limited thereto.

In accordance with a novel aspect, the capability report (or capability information) may further comprise at least one of a supported bandwidth of the relay node 103, the number of antennas of the relay node 103 and a supported modulation order of the relay node 103, but the invention should not be limited thereto.

In accordance with a novel aspect, the capability report may further comprise the at least one aggregated capability information of at least one aggregated group formed by the UE 102 and the at least one relay UE 103. Taken FIG. 2B as an example, the capability report May comprise the aggregated capability information of the aggregated group formed by the UE 202 and relay node 203-1, the aggregated capability information of the aggregated group formed by the UE 202 and relay node 203-2, and the aggregated capability information of the aggregated group formed by the UE 202, relay node 203-1 and the relay node 203-2.

In accordance with a novel aspect, the aggregated capability information of the aggregated group may comprise the aggregated type of the aggregated group. The aggregated type of the aggregated group may be based on the relay type of the relay node in the aggregated group. Taken FIG. 2B as an example, if the relay type of the relay node 203-1 is L1 relay node and the relay type of the relay node 203-2 is L2 relay node, the aggregated type of the aggregated group formed by the UE 202 and relay node 203-1 may be L1 relay node and the aggregated type of the aggregated group formed by the UE 202 and relay node 203-2 may be L2 relay node. That is, the capability report may comprise a plurality of aggregated capability information associated with different relay types of the relay nodes 103.

In addition, when an aggregated group formed by the UE 102 and more than one relay node 103, the aggregated type of the aggregated group may be determined based on different combinations in the aggregated group. For example, in FIG. 2B, if the relay type of the relay node 203-1 is L1 relay node and the relay type of the relay node 203-2 is L2 relay node, the aggregated type of the aggregated group formed by the UE 202, relay node 203-1 and the relay node 203-2 needs to be determined for different combinations in the aggregated group individually. That is, the aggregated type for the combination of the UE 202 and relay node 203-1 and the aggregated type for the combination of the UE 202 and relay node 203-2 need to be determined individually.

In addition, in accordance with a novel aspect, if the relay node 103 comprises more than one relay type, the aggregated capability information may comprise the aggregated types for different relay types of the relay node 103. For example, if the relay node 103 has the functions of L2 relay node and the L1 relay node, the aggregated capability information may comprise the aggregated type of the aggregated group formed by the UE 102 and the relay node 103 with the function of L2 relay node and comprise the aggregated type of the aggregated group formed by the UE 102 and the relay node 103 with the function of L1 relay node.

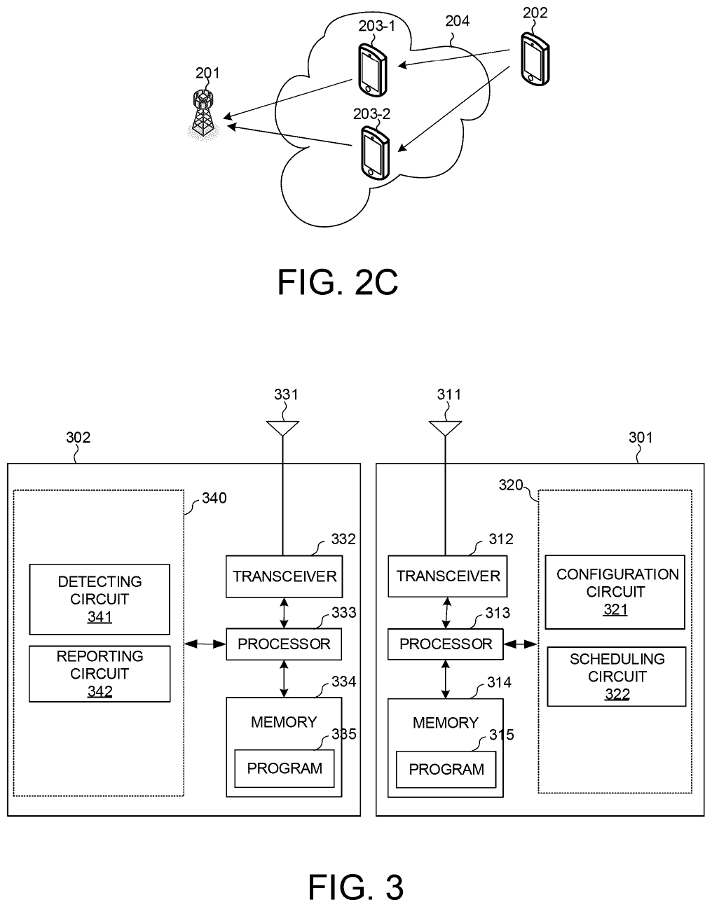

FIG. 3 is a simplified block diagram of a network node and a user equipment (UE) that carry out certain embodiments of the present invention. The network node 301 may be a base station (BS) or a gNB, but the present invention should not be limited thereto. The UE 302 may be a smart phone, a wearable device, an Internet of Things (IoT) device, and a tablet, etc. Alternatively, UE 302 may be a Notebook (NB) or Personal Computer (PC) inserted or installed with a data card which includes a modem and RF transceiver(s) to provide the functionality of wireless communication.

Network node 301 has an antenna array 311 having multiple antenna elements that transmits and receives radio signals, one or more RF transceiver modules 312, coupled with the antenna array 311, receives RF signals from antenna array 311, converts them to baseband signal, and sends them to processor 313. RF transceiver 312 also converts received baseband signals from processor 313, converts them to RF signals, and sends out to antenna array 311. Processor 313 processes the received baseband signals and invokes different functional modules 320 to perform features in network node 301. Memory 314 stores program instructions and data 315 to control the operations of network node 301. Network node 301 also includes multiple function modules that carry out different tasks in accordance with embodiments of the current invention.

Similarly, UE 302 has an antenna array 331, which transmits and receives radio signals. A RF transceiver 332, coupled with the antenna, receives RF signals from antenna array 331, converts them to baseband signals and sends them to processor 333. RF transceiver 332 also converts received baseband signals from processor 333, converts them to RF signals, and sends out to antenna array 331. Processor 333 processes the received baseband signals and invokes different functional modules 340 to perform features in UE 302. Memory 334 stores program instructions and data 335 to control the operations of UE 302. UE 302 also includes multiple function modules and circuits that carry out different tasks in accordance with embodiments of the current invention.

The functional modules and circuits 320 and 340 can be implemented and configured by hardware, firmware, software, and any combination thereof. The function modules and circuits 320 and 340, when executed by the processors 313 and 333 (e.g., via executing program codes 315 and 335), allow network node 301 and UE 302 to perform embodiments of the present invention.

In the example of FIG. 3, the network node 301 may comprise a configuration circuit 321 and a scheduling circuit 322. Configuration circuit 321 may generate the resource configuration based on the capability report from the UE 302. Scheduling circuit 322 may schedule the scheduling to the UE 302 based on the resource configuration.

In the example of FIG. 3, the UE 302 may comprise a detecting circuit 341 and a reporting circuit 342. Detecting circuit 341 may detect the relay node(s). Reporting circuit 342 may transmit the capability report associated with the detected relay node to the network node 301 in an event that a trigger condition is triggered. In an example, the trigger condition may comprise that at least one relay node is changed, capability information of at least one relay node is changed, or the UE 302 changes its serving cell.

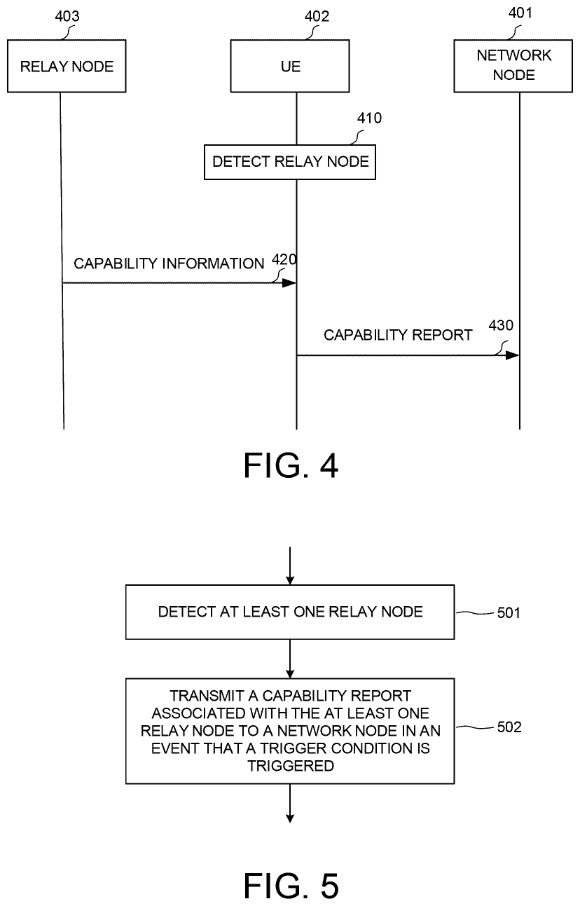

FIG. 4 illustrates a capability reporting in accordance with one novel aspect. In step 410, the UE 401 may detect the relay node 403.

In step 420, after the UE 402 detects the relay node 403, the UE 402 may obtain the capability information from the relay node 403.

In step 430, the UE 402 may transmit a capability report associated with the detected relay node 403 when a trigger condition is triggered. In an example, the trigger condition may comprise that at least one relay node is changed (e.g., the number of the detected relay node is changed), capability information of at least one relay node is changed, or a serving cell of the UE 402 is changed.

FIG. 5 is a flow chart of a capability reporting method in accordance with one novel aspect. In step 501, a user equipment (UE) detects at least one relay node.

In step 502, the UE transmits a capability associated with the at least one relay node in an event that a trigger condition is triggered. The trigger condition may comprise that the at least one relay node is changed, capability information of the at least one relay node is changed, or a serving cell of the UE is changed.

In an example, the at least one relay node is changed comprises that the number of the at least one relay node is changed.

In an example, the at least one relay node is changed comprises that a UE loses a connection to an old relay node but detects a new relay node. As a result, the number of available relay nodes does not change, but the capability information of the new relay node should be reported to the network.

In an example, in the triggered condition of the capability information of the at least one relay node being changed, a relay node may have different capability information corresponding to different configuration, e.g., the operating frequency, the operating bandwidth, or channel condition of the relay UE. The UE may not need to report all capability information of the relay node to the network node, and instead just need to report the required capability information (e.g., corresponding to the current configuration of operating frequency, bandwidth or channel condition of the relay UE). By this way, the signaling overhead for capability report can be reduced. If network node changes some configuration leading to a change of capability information of the relay node, the UE then needs to report the updated capability information corresponding to the new network configuration change.

In an example, the trigger condition comprises that a UE receives request message from the network. The network node may transmit a request message to request capability information. The network node may indicate specific type of capability information. For instance, in the request message, the network node indicates that only L2 relay specific capability information should be reported.

In an example, the network node may announce the required types of capability information the UE should report. The announce message can be carried in a UE-specific message (e.g., RRC message) or in a broadcasted/multi-casted message (e.g., broadcasted by included in system information). For example, a network node may only support L2 relay, and thus it is indicated in the system information that only the L2 relay specific information should be reported. A UE then reports only the indicated capability information when triggering condition(s) occur.

In an example, a UE may be configured to periodically report the capability information. The UE transmit capability information when the time duration since the last report has exceeded a time duration threshold T, where T can be controlled by the network as a cell-specific, area-specific, or UE-specific configuration. T can be modelled by a timer, wherein a UE restarts the timer when transmitting a report for the capability information. When the timer expires, the UE is triggered to transmit capability information.

In an example, the trigger condition comprises that a UE connects to a new serving cell. For instance, a UE just connects to the network via RRC connection establishment, and the network node has not acquired the up-to-date capability information. The capability information for aggregated group(s) of the UE can be reported together with the capability report of this UE during connection establishment, wherein the connection here may mean access stratum (AS) layer connection, non-access stratum (NAS) layer connection or core network level connection.

In an example, the trigger condition comprises that a UE changes a serving cell. For example, after a UE performs handover to a new cell (target cell), the UE can be triggered to report capability information for its aggregated group because the target cell may not have the latest capability information.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
detecting, by a user equipment (UE), at least one relay node; and
transmitting, by the UE, a capability report associated with the at least one relay node to a network node in an event that a trigger condition is triggered, wherein the trigger condition comprises that the at least one relay node is changed, capability information of the at least one relay node is changed, or a serving cell of the UE is changed.

2. The method of claim 1, wherein the at least one relay node is changed comprises that a number of the at least one relay node is changed.

3. The method of claim 1, wherein the capability report comprises the capability information of the at least one relay node.

4. The method of claim 3, wherein the capability information of the at least one relay node comprises at least one relay type of the at least one relay node.

5. The method of claim 4, wherein one of the at least one relay node comprises more than one relay types.

6. The method of claim 1, wherein the capability report further comprises at least one aggregated capability information of at least one aggregated group formed by the UE and the at least one relay UE.

7. The method of claim 6, wherein an aggregated type of the aggregated group is based on the relay type of the relay node in the aggregated group.

8. The method of claim 6, wherein the capability report comprises a plurality of aggregated capability information associated with different relay types of the at least one relay node.

9. The method of claim 1, further comprising:
transmitting, by the UE, separated capability reports for the at least one relay node and the UE.

10. The method of claim 1, wherein the capability report further comprises at least one of a supported bandwidth, a number of antennas and a supported modulation order of the at least one relay node.

11. A user equipment (UE), comprising:
a processor, detecting at least one relay node; and
a transmitter, transmitting a capability report associated with the at least one relay node to a network node in an event that a trigger condition is triggered, wherein the trigger condition comprises that the at least one relay node is changed, capability information of the at least one relay node is changed, or a serving cell of the UE is changed.

12. The UE of claim 11, wherein the at least one relay node is changed comprises that a number of the at least one relay node is changed.

13. The UE of claim 11, wherein the capability report comprises the capability information of the at least one relay node.

14. The method of claim 13, wherein the capability information of the at least one relay node comprises at least one relay type of the at least one relay node.

15. The method of claim 14, wherein one of the at least one relay node comprises more than one relay types.

16. The UE of claim 11, wherein the capability report further comprises at least one aggregated capability information of at least one aggregated group formed by the UE and the at least one relay UE.

17. The UE of claim 16, wherein an aggregated type of the aggregated group is based on a relay type of the relay node in the aggregated group.

18. The UE of claim 16, wherein the capability report comprises a plurality of aggregated capability information associated with different relay types of the at least one relay node.

19. The UE of claim 11, wherein the transmitter further transmits separated capability reports for the at least one relay node and the UE.

20. The UE of claim 11, wherein the capability report further comprises at least one of a supported bandwidth, a number of antennas and a supported modulation order of the at least one relay node.
